(19) United States
(12) Patent Application Publication
(10) Pub. No.: US 2003/0038504 A1
(43) Pub. Date: Feb. 27, 2003

(54) Recreational vehicle with latch assemblies for storage spaces

(76) Inventor: Johnnie R. Crean, Chino, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/935,480

(22) Filed: Aug. 22, 2001

Related U.S. Application Data
(60) Provisional application No. 60/314,512, filed on Aug. 21, 2001.

(51) Int. Cl. B60P 3/32

(52) U.S. Cl. 296/156; 296/164

(57) ABSTRACT

A recreational vehicle having a storage compartment in the subfloor area. The storage compartment is accessible via an access door positioned in outer housing of the recreational vehicle. A latching mechanism is mounted on the access door that secures the non-hinged corners, such as the bottom corners, when the access door is hinged at the top, so as to more securely latch the door. Force multiplier members are included in the latching mechanism such that greater force is applied to the securing members in response to user actuation of an external latch.

### RELATED APPLICATIONS

This application claims the benefit of U.S. Provisional Application No. ______, filed on Aug. 21, 2001, entitled “RECREATION VEHICLE WITH LATCH ASSEMBLIES FOR STORAGE SPACE.”, which is hereby incorporated by reference in its entirety.

### BACKGROUND OF THE INVENTION

1. Field of the Invention

The present invention relates to recreational vehicles and, in particular, concerns a recreational vehicle with an improved latching mechanism for latching the access doors to storage compartments in a shut position.

2. Description of the Related Art

Recreational vehicles are vehicles that are commonly used for camping and other traveling purposes. Typically, recreational vehicles will come in one of two basic configurations, either a self-propelled motorhome or a trailer vehicle that is towed by another powered vehicle.

Recreational vehicles can be quite elaborate having most, if not all, of the amenities of the typical home. Generally, recreational vehicles will include such things as sleeping accommodations, kitchens, sitting areas, and bathrooms complete with shower facilities. All of these facilities are mounted onto a chassis which can limit storage space within the livable floor space of the recreational vehicle. More specifically, generally the livable floor space of the vehicle is limited by the chassis of the recreational vehicle and the basic living accommodations occupy a significant portion of this floor space. Moreover, there is currently a maximum size restriction on trailers of 400 square feet which further limits the space available in the recreational vehicle. Typically, to accommodate all of the sleeping, bathing, cooking, and other living accoutrements, there is a significant lack of space that can be used for storage of auxiliary equipment and gear.

In particular, most people who are camping often wish to bring additional items, such as clothing, tools, outdoor camping gear and recreational gear, along with them while they are traveling. Due to the space limitations within the living section of the recreational vehicle, the typical recreational vehicle is not configured to accommodate significant storage in the living section. Consequently, most recreational vehicles include storage compartments that are mounted in the space between the floor of the living space of the trailer and the bottom of the chassis. This space allows for storage of additional equipment and is typically accessed through access doors that are mounted along the side of the recreational vehicle. Generally, these access doors are hinged mounted along the upper surface of the door so as to swing upward to allow access to the space therein. Typically, these doors are latched with a latching mechanism that extends to the sidewalls of the surrounding wall so as to inhibit inadvertent opening of the access door. Alternatively, the latching mechanism extends to a bottom surface of the surrounding frame immediately underneath the accessible latch. Typically, these latching mechanisms are lockable so as to inhibit unauthorized entry into the access areas.

One particular problem with the storage compartment configuration is that the access doors are mounted on the outside of the vehicle and are thus exposed to environmental conditions. Consequently, the access doors are typically weather sealed to prevent unwanted intrusion of water, dirt or dust into the storage compartment. Often, the equipment stored in the storage compartment is equipment the user does not want getting dirty during travel.

As the recreational vehicle is traveling down the road, the door is subject to vibrational motion that is transmitted via the wheels and the frame and is further subject to vibrational motion as a result of being buffeted by the wind while the vehicle is traveling. This vibrational motion can result in the access door vibrating with respect to the surrounding frame, and this particular vibration occurs more significantly at the corners of the doors that are located away from the latching mechanism. Over time, this vibrational motion may result in damage to the door or the surrounding frame, or result in damage to the weather tight seals between the frame and the door.

Moreover, a further difficulty with many access doors is that the latching mechanism is often difficult to actuate by the user of the recreational vehicle. Many purchasers of recreational vehicles are older individuals. As recreational vehicles have increased in size, the storage space has also increased in size as have the access doors. Consequently, for many users of recreational vehicles, the access doors are heavy and the latching mechanisms are often difficult to actuate. The difficulty in actuating the latching mechanism is further compounded by the fact that dirt and dust may occlude the latching mechanism thereby inhibiting easy removal of the latching mechanism from its secured position.

From the foregoing, it will be appreciated that there is a need for recreational vehicles that have storage compartments with access doors that are more readily actuated by the users. Moreover, there is a further need for latching mechanisms that are able to secure the access doors at the corners to inhibit damage to the weather tight seals or potential damage to the securing door or storage compartment.

### SUMMARY OF THE INVENTION

The aforementioned needs are satisfied by the recreational vehicle of the present invention which, in one aspect, comprises a frame that is attached to a plurality of wheels so as to permit rolling movement of the frame over the ground and a housing that is attached to the frame so as to define an interior living space wherein a floor is mounted on the frame so as to be elevated above the wheels to thereby define the floor of the interior living space of the vehicle and a subfloor space into which a plurality of storage compartments are positioned wherein the storage compartments include a hinged access door and a latching mechanism that is adapted to latch the two corners of the access door opposite the hinge to thereby secure the bottom corners of the door in a closed configuration.

In one particular implementation, the access doors are hinged on a first side and the latching mechanism is adapted to be positioned proximate the corners of the second side of the access door to the storage compartment. In one particular implementation, the first side is an upper side of the access door and the second side is a lower side.

In one particular embodiment, the latching mechanism includes a user actuatable latch that extends through to the outer side of the housing such that user manipulation of the latch will result in rotation of an attached rotating cam member on an interior surface of the door resulting in lateral motion of interconnecting rods attached thereto. The interconnecting rods are preferably connected to rotating bell cranks, which are, in turn, connected to locking members. The locking members can either be positioned at the interface between the bottom of the access door and the subfloor wall or at the side of the access door and the subfloor wall.

By securing the doors at a position adjacent the non-hinged corners of the access door, the negative effects of vibration on the access doors is reduced. In particular, a better weather seal is maintained and the likelihood of damage over time as a result of vibration at the corners is reduced. Moreover, the use of bell cranks results in a mechanical advantage in extracting the locking members from the locking apertures which thereby makes the door easier to open. These and other objects and advantages will be more apparent from the following description taken in conjunction with the accompanying drawings.

### BRIEF DESCRIPTION OF THE DRAWINGS

FIG. 1A is a first recreational vehicle having the improved storage compartments of the preferred embodiments;

FIG. 1B is a second recreational vehicle incorporating the improved storage compartments of the preferred embodiments;

FIG. 2 is a layout drawing illustrating the layout of a typical inner living space of the recreational vehicle of FIG. 1A;

FIGS. 3A and 3B illustrate a first embodiment of the latching mechanism for the storage compartment access door;

FIGS. 4A and 4B are detailed views of a locking member of the latching mechanism of FIGS. 3A and 3B;

FIGS. 5A and 5B are detailed views of the latching mechanism actuation member;

FIGS. 6A and 6B illustrate an alternative embodiment of a latching mechanism similar to the latching mechanism of FIGS. 3A and 3B.

### DETAILED DESCRIPTION OF THE PREFERRED EMBODIMENT

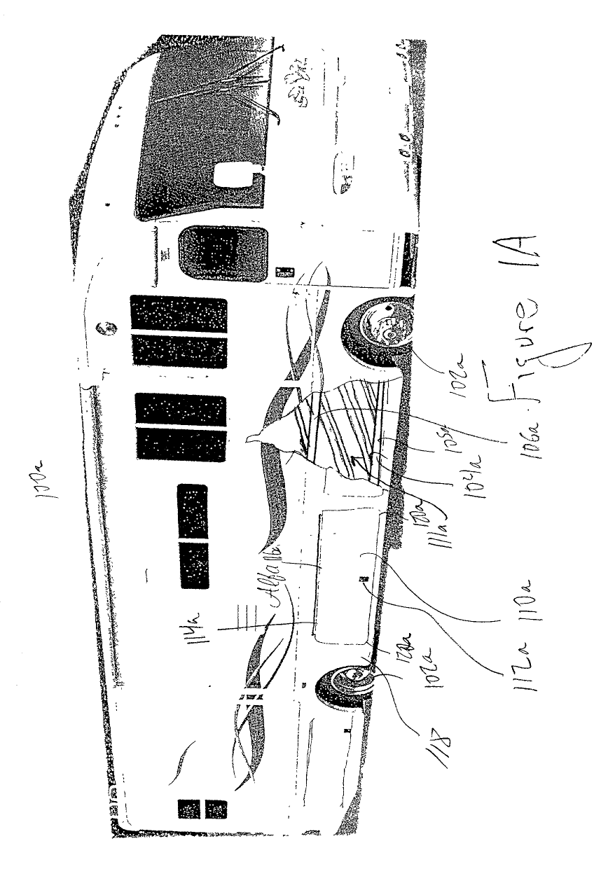

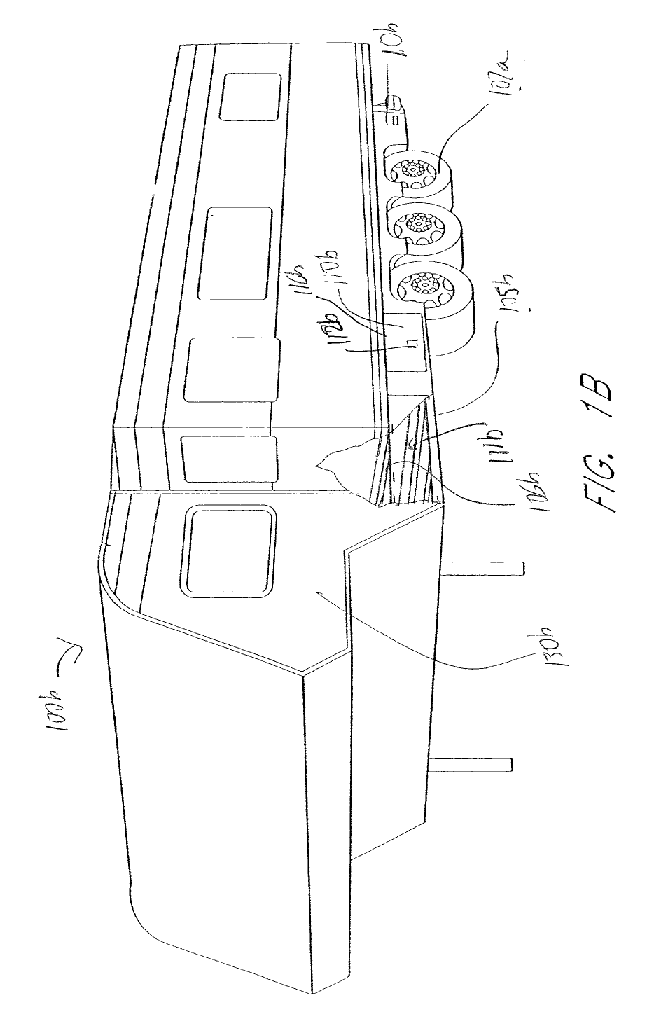

Reference will now be made to the drawings wherein like numerals refer to like parts throughout. FIGS. 1A and 1B illustrate a typical recreational vehicle 100a, 100b. As is illustrated in FIG. 1A, the recreational vehicle 100a comprises a motorhome that is a self-propelled vehicle. As is further illustrated in FIG. 1A, the motorhome 100a includes a plurality of wheels 102a that are attached to a frame structure 104a so as to permit rolling movement of the motorhome over the ground. The frame structure 104a can be similar to the frame structure as disclosed in Application's co-pending application, application Ser. No. 09/728,946, filed Dec. 1, 2000, entitled “MOTORHOME WITH INCREASED INTERIOR CEILING HEIGHT”, which is hereby incorporated by reference in its entirety. As is also illustrated in FIG. 1A, the recreational vehicle has a living space floor 106a that is elevated above the lowest section 105 of the chassis. Hence, a subfloor area 111a is defined between the living space floor 106a and the lower subfloor members 105a.

The subfloor space 111a can then be divided into a plurality of storage compartments that are accessible via the access doors 110a. Each of the access doors 110a have, in this embodiment, hinges 114 located along an upper surface 116 of the access door 110a to permit the doors to be moved between an open and closed configuration. Also, an exposed latch 112a is accessible to the outside of the vehicle to permit the user to be able to open the access door to the storage compartment. As will be described in greater detail below, the latching mechanism associated with the latch 112a preferably engages between the non-hinged corners 120a of the storage compartment and the wall portions 122a of the side of the vehicle to ensure better security of the access door 110a.

As is illustrated in FIG. 1B, the improved access door can be used not only on motorhomes, but also on trailer, such as fifth-wheel trailers, that also have interior living spaces with an interior living space floor 106b and a subfloor 105b so as to define a subfloor area or space 111b into which storage compartments can be formed. Moreover, the access doors 110b have the same basic configuration as the access doors 110a as described above in connection with FIG. 1A and further as described below in connection with the remaining figures. Hence, it will be appreciated that the following description of the latching mechanism of the access door 110 should not be limited to any particular type of recreational vehicle but is actually adaptable to any of a number of different types of recreational vehicles.

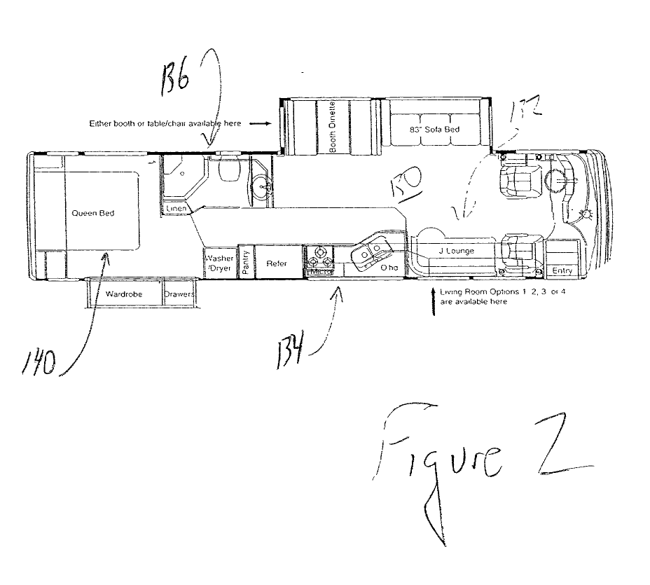

As is illustrated in FIG. 2, the recreational vehicle has an interior living space 130 that is positioned on the floor 106 and includes many of the accoutrements of a home including sitting locations 132, a kitchen 134, a bathroom 136 and a bedroom 140. It will, of course, be appreciated that the exact configuration of the living space 130 within the vehicle 100 can vary significantly from vehicle to vehicle.

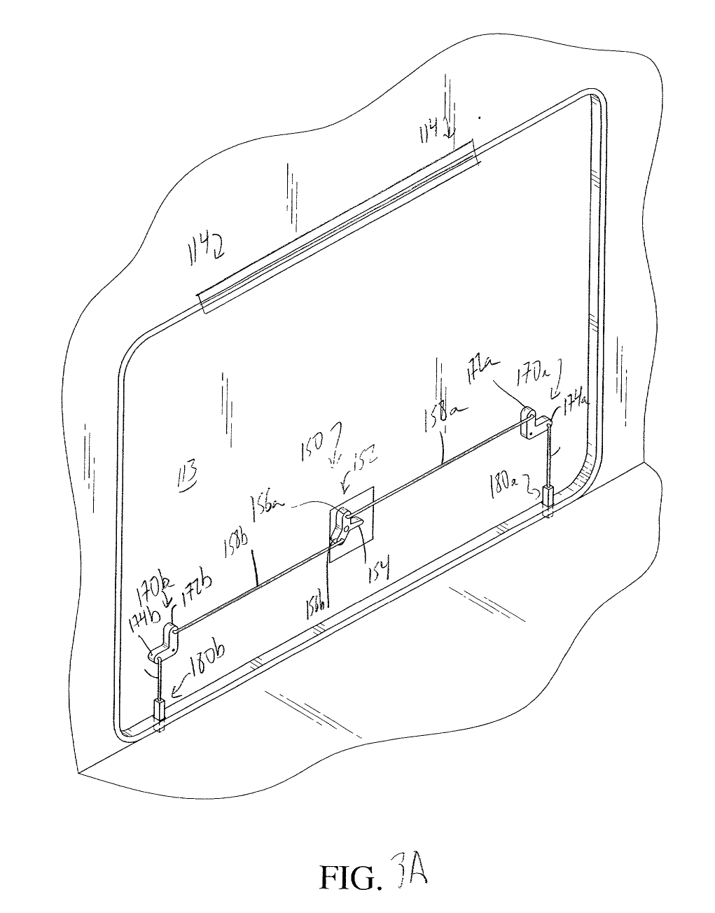

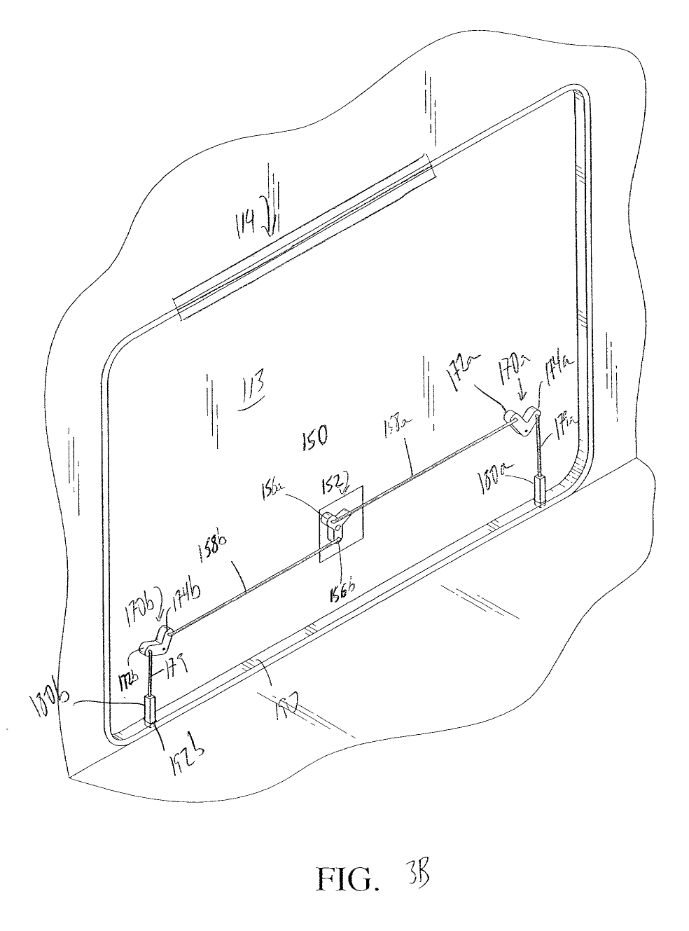

Referring now to FIGS. 3A and 3B, one embodiment of the latching mechanism 150 will be described. As is illustrated in FIGS. 3A and 3B, the latching mechanism 150 includes the latch 112 which is coupled to a rotating cam member 152 in a manner that will be described in greater detail below. Basically, outward operation of the latch 112 results in rotation of the cam member 152 between the locked position shown in FIG. 3A and the unlocked position shown in FIG. 3B. The cam member 152 includes an engagement arm 154 which engages with the latch 112 in a manner that will be described in greater detail below and two mounting arms 156a, 156b.

Two interconnecting members 160a, 160b are attached to the mounting arms 156a, 156b, respectively, such that rotation of the cam member 152 results in lateral movement of the interconnecting members 158a, 158b in the direction of the arrow 164. The interconnecting members 158a, 158b are respectively attached to two bell crank members 170a, 170b that are pivotally attached to the inner surface 113 of the door 110 so as to rotate between a secured position shown in FIG. 3A and an open position shown in FIG. 3B. As is illustrated, the bell crank members 170a, 170b define a first and a second leg 172, 174 such that the bell crank member 170a, 170b has a generally “L” shape.

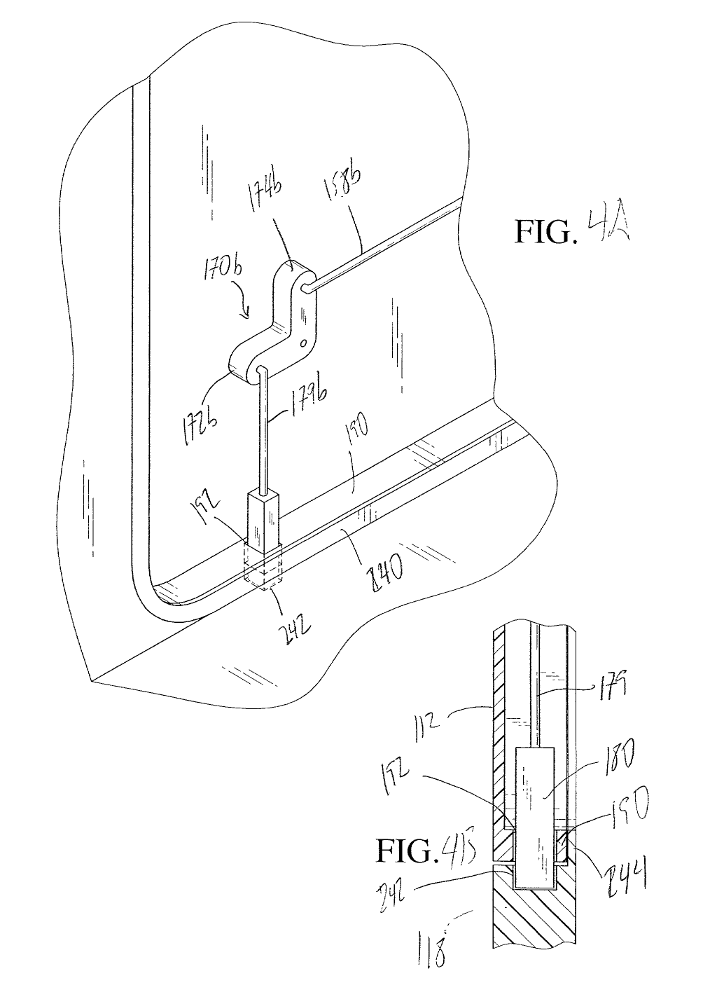

The interconnecting members 158a, 158b are connected to the second leg 174b and a locking rod 179a is preferably connected to the first leg 172a, 172b. The locking rod 179a, 179b is then connected to a shaped locking member 180a, 180b. Since the bell cranks 170a, 170b pivot, the locking rods 179a, 179b and the shaped locking members 180a, 180b move vertically to either move the shaped locking members 180a, 180b into or out of the openings 192a, 192b in the manner described in greater detail hereinbelow in reference to FIGS. 4A and 4B. It will be appreciated that while bell cranks 170a, 170b are used in this embodiment, member that transfers the horizontal force vertically can also be used without departing from the spirit of the present invention.

As will be described in greater detail below, the relative sizes of the legs 174a, 174b are preferably sized with respect to each other such that the bell cranks 170a, 170b acts as a force multiplier member such that rotation of the cam member 152 results in greater force being exerted on the locking member 180a, 180b. As is illustrated in FIGS. 3A and 3B, the locking members 191 are positioned adjacent the non-hinged corners 200 of the door so as to secure the non-hinged corner in a locked configuration which thereby reduces the negative effects of vibration on the seal between the door and the wall.

FIGS. 4A and 4B illustrate one exemplary locking of the access door 110. It will be appreciated, however, that this is simply illustrative of one configuration of the door and any of a number of different configurations can be used with the locking mechanism 150 without departing from the spirit of the present invention.

In this implementation, the shaped locking member 180 extends through the opening 192 in the lip 190 of the door 110. The lip 190 abuts against a flange 244 formed in the wall 118 so that the storage compartment can be sealed. An opening 242 is formed in the wall such that when the cam member 152 is rotated, the shaped locking member 180 can be positioned through the opening 192 in the lip 190 of the door 110 into the opening 242 of the wall 118 thereby securely latching the door 112 to thereby inhibit opening of the door 112. Preferably, the shaped locking member 180 is shaped with respect to the opening 242 such that the outer walls of the shaped locking member 180 engage with the inner walls of the opening such that the engagement urges the lip 190 into contact with the flange 244 of the wall to thereby seal the storage compartment.

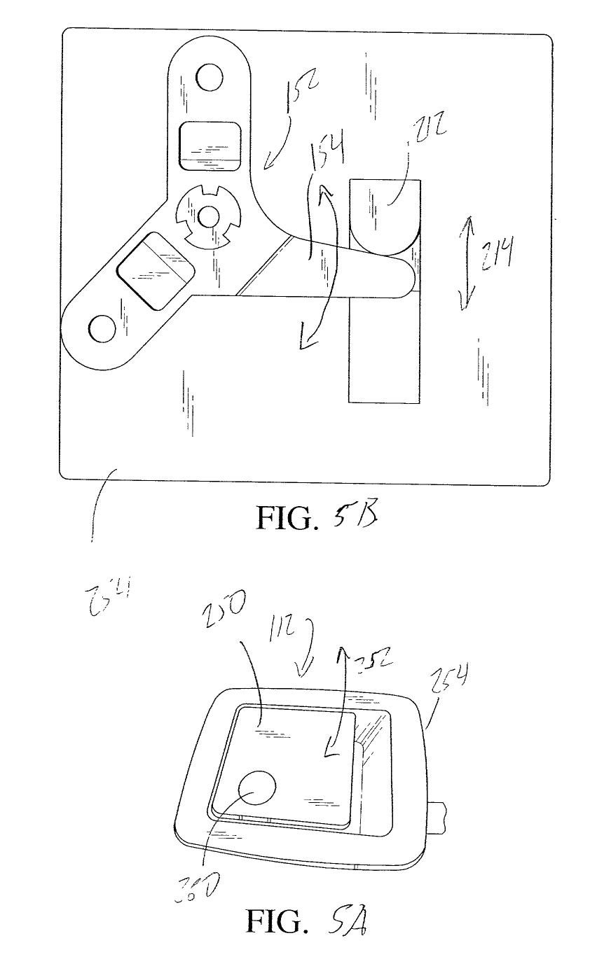

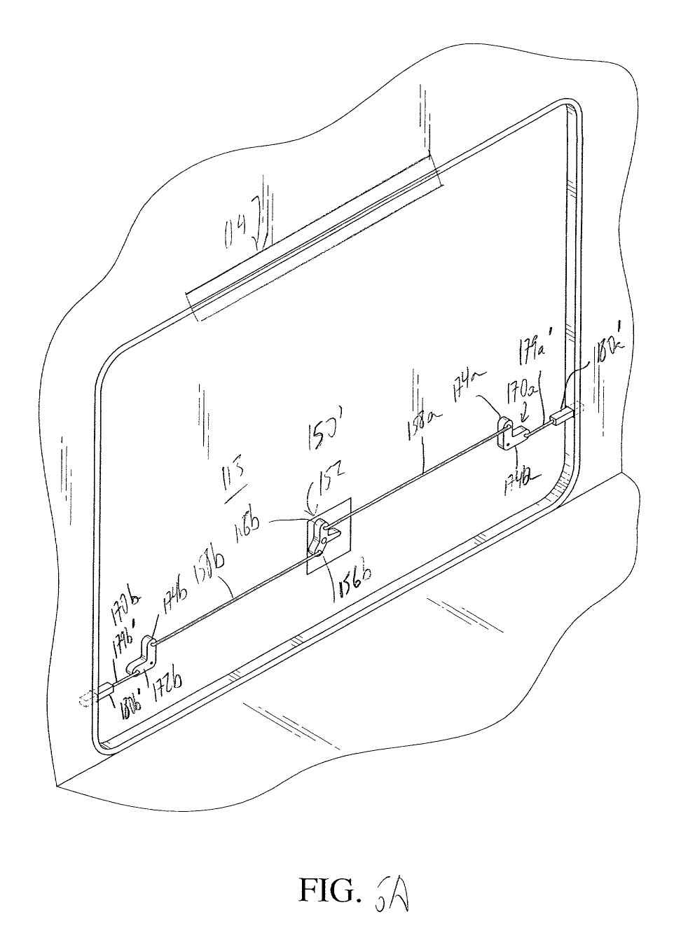

FIGS. 5A and 5B illustrate the operation of the rotating cam member 152 in connection with the latch 112. FIG. 5A is a front view of the latch 112 wherein the latch 112 includes a lever member 250 that pivots in the direction of arrow 252 such that an angled tab (not shown) on an interior surface of the lever member 250 engages with a slide member 212 that then engages with the engagement arm 154 of the rotating cam member 152. Basically, the angled tab extends through the latch assembly housing 254 and engages with the slide member 212 such that the slide member 212 slides in the direction of the arrow 214 in FIG. 5B causing the rotating cam member to rotate in a clockwise direction when the latch is being manipulated into an open position. The workings of the rotating cam member is further described in U.S. Pat. No. 5,058,937 entitled “Flush Door Latch Assembly” issued to Miehe et al., which is hereby incorporated by reference in its entirety.

Hence, the embodiment of the latch mechanism described in connection with FIGS. 3A, 3B, 4, 5A, and 5B provide for a latching mechanism that is better able to secure the corner of the door. Moreover, the use of the rotating bell crank members or their equivalents allow for the locking members to be positioned along the bottom surface of the door as opposed to along the side surface as is the custom in access doors for recreational vehicles. Moreover, the use of the rotating bell crank members can also create a mechanical advantage due to the lever arms such that greater force can be exerted against the locking member to either position the locking member in the locking receptacle or remove the locking member from the locking receptacle without requiring the user to exert greater force on the latch.

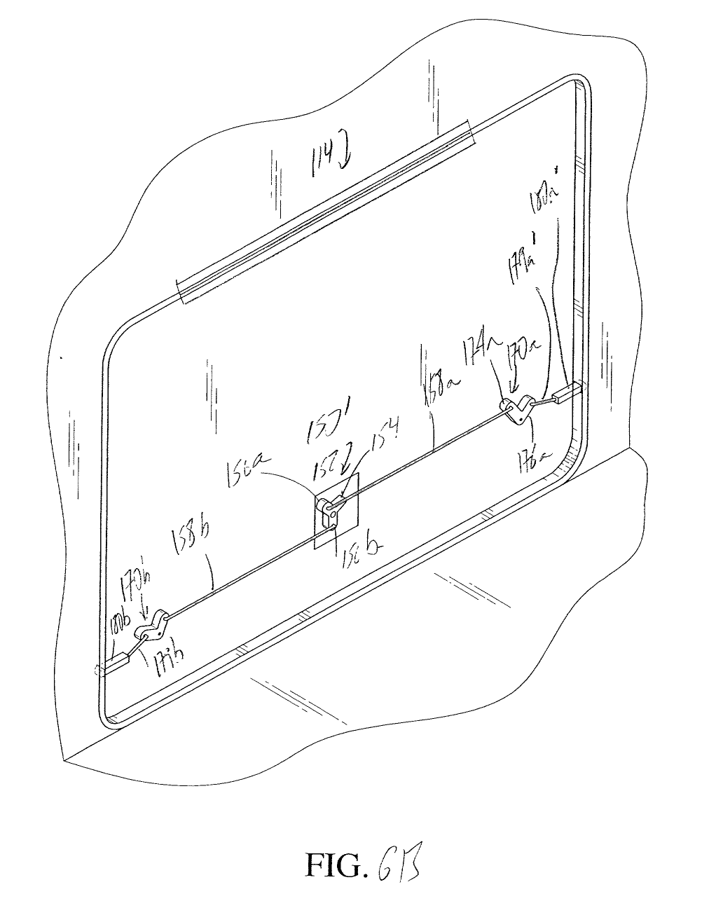

As is illustrated in FIGS. 6A and 6B, an alternative embodiment of the invention utilizing the rotating bell crank members 170a, 170b can also be implemented wherein the locking members extend into the sides of the access door 110 in the manner shown. Again, the use of the rotating bell crank members creates the mechanical advantage which results in easier opening of the locks.

Although the foregoing description of the embodiments of the invention has shown, described and pointed out the fundamental novel features of the invention, it will be understood that various omissions, substitutions and changes in the form of the detail of the apparatus as illustrated, as well as uses thereof, may be made by those skilled in the art without departing from the spirit of the invention. Consequently, the scope of the invention should not be limited to the foregoing discussion, but should be defined by the appended claims.

What is claimed is:

1. A recreational vehicle comprising:
a frame mounted on wheels adapted to be rollably moved over the ground;
a housing having an outer surface built about the frame so as to define an inner living space wherein the frame defines a floor of the inner living space and wherein the frame includes a lower member so as to define a subfloor space;
at least one storage compartment formed in the subfloor space;
at least one access door hingeably mounted to the outer surface of the housing adjacent the subfloor space such that the at least one access door can be moved between an open and a closed position; and
a latching mechanism that is attached to the at least one access door wherein the latching mechanism includes a first and second securing members that are movable between a latched and open position, wherein in the latched position, the securing members secure the non-hinged corners of the access door so as to inhibit movement of the non-hinged corners with respect to the outer surface of the housing.

2. The vehicle of claim 1, wherein the recreational vehicle comprises a trailer.

3. The vehicle of claim 1, wherein the recreational vehicle comprises a motorhome.

4. The vehicle of claim 1, wherein the latching mechanism comprises a latch that is positioned on the outer surface of the at least one access door.

5. The vehicle of claim 4, wherein the latching mechanism further comprises a rotating cam member that rotates upon user activation of the latch.

6. The vehicle of claim 5, wherein the latching mechanism further comprises a first and second interconnecting member that are mechanically coupled to the rotating cam member such that the first and second interconnecting members move in a first lateral direction in response to rotation of the rotating cam member.

7. The vehicle of claim 6, wherein the latching mechanism further comprises a first and second pivoting members that are mechanically coupled to the first and second interconnecting member such that lateral movement of the interconnecting member results in pivoting movement of the first and second pivoting members.

8. The vehicle of claim 7, wherein the first and second pivoting members comprise bell crank members pivotally mounted to the access door.

9. The vehicle of claim 7, wherein the first and second securing members are mechanically coupled to the first and second pivoting members such that pivoting motion of the first and second pivoting members results in lateral movement of the first and second securing members in a second direction that intersects the first direction.

10. The vehicle of claim 9, wherein the first and second interconnecting members extend horizontally and the first and second locking members extend vertically such that the first and second locking members lock the bottom edges of the access door adjacent the bottom corners of the access door.

11. The vehicle of claim 9, wherein the first and second pivoting members are configured so as to force multiply the force being exerted on the first and second locking members when pivoted in response to lateral movement of the first and second interconnecting members.

12. The vehicle of claim 1, wherein the outer housing of the wall includes openings that receive the first and second securing members in the locked configuration such that relative movement between the access door and the outer surface of the housing is inhibited.

13. The vehicle of claim 12, wherein the first and second securing members are shaped so as to urge the at least one access door against a portion of the outer wall of the housing so as to seal the storage compartment.

14. A recreational vehicle comprising:
a frame mounted on wheels adapted to be rollably moved over the ground;
a housing having an outer surface built about the frame so as to define an inner living space wherein the frame defines a floor of the inner living space and wherein the frame includes a lower member so as to define a subfloor space;
at least one storage compartment formed in the subfloor space;
at least one access door hingeably mounted to the outer surface of the housing adjacent the subfloor space such that the at least one access door can be moved between an open and a closed position; and
a latching mechanism that is attached to the at least one access door wherein the latching mechanism includes a first and second securing members that are movable between a latched and open position, wherein in the latched position, the securing members secure the access door so as to inhibit movement of with respect to the outer surface of the housing and wherein the latching mechanism includes a user actuatable latch and force multiplier members such that user activation of the latch results in movement of the first and second securing members with greater force.

15. The vehicle of claim 14, wherein the force multiplier members comprise a pair of bell cranks having a first and a second leg that are configured such that application of force in one direction on one leg results in an increase in resulting force being exerted by the second leg.

16. The vehicle of claim 15, wherein the securing members are mechanically coupled to the second leg of the bell cranks and the user actuatable latch is mechanically coupled to the first leg of the bell cranks.

17. The vehicle of claim 14, wherein the latching mechanism further comprises a rotating cam member that rotates upon user activation of the latch.

18. The vehicle of claim 17, wherein the latching mechanism further comprises a first and second interconnecting member that are mechanically coupled to the rotating cam member such that the first and second interconnecting members move in a first lateral direction in response to rotation of the rotating cam member.

19. The vehicle of claim 18, wherein the latching mechanism further comprises a first and second pivoting members that are mechanically coupled to the first and second interconnecting member such that lateral movement of the interconnecting member results in pivoting movement of the first and second pivoting members.

20. The vehicle of claim 18, wherein the first and second securing members are mechanically coupled to the first and second pivoting members such that pivoting motion of the first and second pivoting members results in lateral movement of the first and second securing members in a second direction that intersects the first direction.

21. The vehicle of claim 20, wherein the first and second interconnecting members extend horizontally and the first and second locking members extend vertically such that the first and second locking members lock the bottom edges of the access door adjacent the bottom corners of the access door.

22. The vehicle of claim 18, wherein the first and second securing members extend horizontally and lock the side edges of the access door adjacent the bottom corner of the access door.

23. The vehicle of claim 22, wherein the latching mechanism further comprises a lock that inhibits user actuation of the latch.
